(19) United States
(12) Patent Application Publication
(10) Pub. No.: US 2020/0189530 A1
(43) Pub. Date: Jun. 18, 2020

(54) FLOW PATH SWITCHING BOX AND VEHICLE CLEANER SYSTEM

(71) Applicant: KOITO MANUFACTURING CO., LTD., Tokyo (JP)

(72) Inventors: Akinobu Kubota, Shizuoka-shi (JP); Masaaki Sato, Shizuoka-shi (JP)

(73) Assignee: KOITO MANUFACTURING CO., LTD., Tokyo (JP)

(21) Appl. No.: 16/710,840

(22) Filed: Dec. 11, 2019

(30) Foreign Application Priority Data
Dec. 12, 2018 (JP) 2018-232500

(51) Int. Cl. B60S 1/60; F16K 27/00; F16K 27/02

(52) U.S. Cl. CPC B60S 1/603; B60S 1/0848; F16K 27/029; F16K 27/003

(57) ABSTRACT

A flow path switching box includes a housing, a chamber and a plurality of solenoid valves. The housing including an inflow port and a plurality of discharge ports. The chamber connected to the inflow port. The plurality of solenoid valves provided in the housing, the plurality of solenoid valves each including a stator and a movable element movable relative to the stator. The plurality of solenoid valves have inlets connected to the chamber and outlets connected respectively to the discharge ports. The plurality of solenoid valves are configured to switch to permitting and not permitting discharge of a fluid from the outlets independently of each other. The plurality of solenoid valves are arranged in parallel to each other in a moving direction of the movable element.

### CROSS-REFERENCE TO RELATED APPLICATIONS

The present application claims priority from Japanese Patent Application No. 2018-232500, filed on Dec. 12, 2018, the entire content of which is incorporated herein by reference.

### TECHNICAL FIELD

The present invention relates to a flow path switching box and a vehicle cleaner system.

### BACKGROUND ART

Vehicles in recent years have been equipped with cameras. Information acquired by a camera is output to, for example, a vehicle ECU that controls a host vehicle. For example, JP-A-2001-171491 discloses a vehicle cleaner capable of cleaning such a camera with a cleaning liquid.

### SUMMARY

A vehicle has developed to be equipped with a plurality of cameras and sensors. It is conceivable to clean the plurality of cameras and sensors with the vehicle cleaner described above. In this case, it is considered to integrate a plurality of vehicle cleaners into a vehicle cleaner system and equip the vehicle with the system.

When such a vehicle cleaner system is implemented, it is necessary to transport a fluid from a tank storing the cleaning liquid to each cleaner unit. When the piping branches from a common pipeline to each cleaner unit, a large number of solenoid valves are required. In a case where the large number of solenoid valves are provided at a plurality of different parts of the vehicle, attachment work would be complicated when the vehicle cleaner system is mounted on the vehicle.

For this reason, the present invention provides a vehicle cleaner system that is easily attached to a vehicle and a flow path switching box used in the vehicle cleaner system.

A flow path switching box includes a housing, a chamber and a plurality of solenoid valves. The housing including an inflow port and a plurality of discharge ports. The chamber connected to the inflow port. The plurality of solenoid valves provided in the housing, the plurality of solenoid valves each including a stator and a movable element movable relative to the stator. The plurality of solenoid valves have inlets connected to the chamber and outlets connected respectively to the discharge ports. The plurality of solenoid valves are configured to switch to permitting and not permitting discharge of a fluid from the outlets independently of each other. The plurality of solenoid valves are arranged in parallel to each other in a moving direction of the movable element.

A vehicle cleaner system includes the flow path switching box, a plurality of cleaners connected respectively to the outlets, and a tank connected to the inflow port and storing a cleaning liquid.

According to the present invention, a vehicle cleaner system that is easily attached to a vehicle and a flow path switching box used in the vehicle cleaner system are provided.

### BRIEF DESCRIPTION OF DRAWINGS

FIG. 1 is a top view of a vehicle equipped with a cleaner system;

FIG. 2 is a block diagram of a vehicle system;

FIG. 3 is a block diagram of the cleaner system;

FIG. 4 is a perspective view of a second flow path switching box; and

FIG. 5 is a cross-sectional view of a first solenoid valve.

### DETAILED DESCRIPTION OF EMBODIMENTS

Hereinafter, a first embodiment of the present invention will be described with reference to the drawings. Descriptions of members having the same reference numerals as members that are already described in the description of the present embodiment will be omitted for convenience of description. Dimensions of members shown in the drawings may be different from actual dimensions thereof for convenience of description.

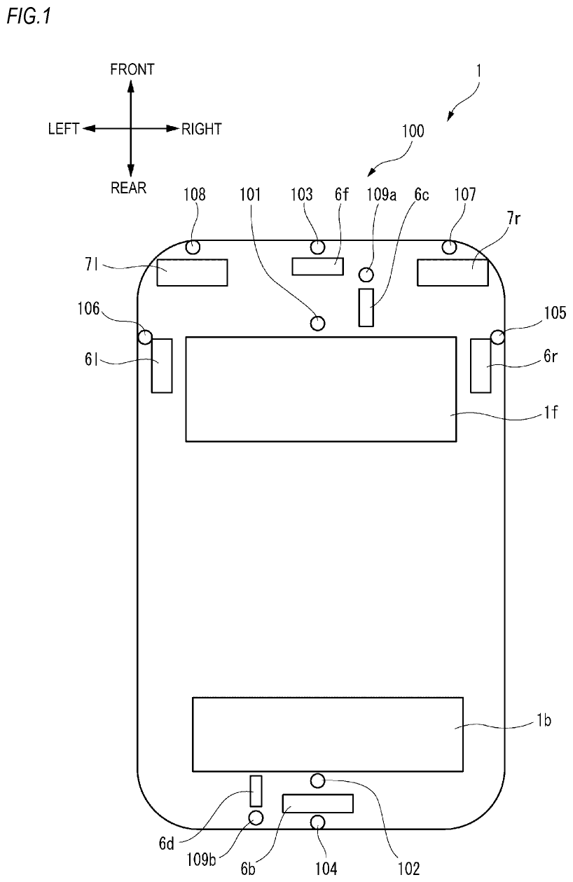

In the description of the present embodiment, “left-right direction”, “front-rear direction”, and “up-down direction” are appropriately referred to for convenience of description. These directions are relative directions set for a vehicle 1 shown in FIG. 1. Herein the “up-down direction” includes “upward direction” and “downward direction”. The “front-rear direction” includes “forward direction” and “rearward direction”. The “left-right direction” includes “leftward direction” and “rightward direction”.

FIG. 1 is a top view of the vehicle 1 equipped with a vehicle cleaner system 100 (hereinafter referred to as the cleaner system 100) according to the present embodiment. The vehicle 1 includes the cleaner system 100. In the present embodiment, the vehicle 1 is an automobile that can travel in an automatic driving mode.

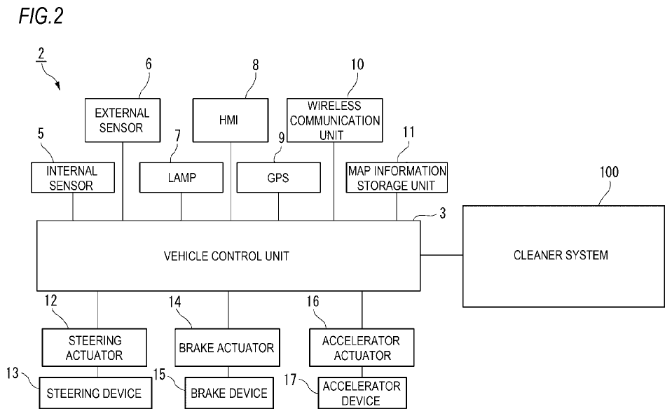

First, a vehicle system 2 of the vehicle 1 will be described with reference to FIG. 2. FIG. 2 shows a block diagram of the vehicle system 2. As shown in FIG. 2, the vehicle system 2 includes a vehicle control unit 3, an internal sensor 5, an external sensor 6, a lamp 7, a Human Machine Interface (HMI) 8, a Global Positioning System (GPS) 9, a wireless communication unit 10, and a map information storage unit 11. The vehicle system 2 further includes a steering actuator 12, a steering device 13, a brake actuator 14, a brake device 15, an accelerator actuator 16, and an accelerator device 17.

The vehicle control unit 3 includes an electronic control unit (ECU). The vehicle control unit 3 includes a processor such as a Central Processing Unit (CPU), a Read Only Memory (ROM) in which various vehicle control programs are stored, and a Random Access Memory (RAM) in which vehicle control data are temporarily stored. The processor loads a program designated from the various vehicle control programs stored in the ROM onto the RAM and executes processing in cooperation with the RAM. The vehicle control unit 3 controls traveling of the vehicle 1.

The internal sensor 5 may acquire information of a host vehicle. The internal sensor 5 is at least one of an acceleration sensor, a speed sensor, a wheel speed sensor, a gyro sensor, and the like. The internal sensor 5 acquires information of the host vehicle, which includes a traveling state of the vehicle 1, and outputs the information to the vehicle control unit 3.

The internal sensor 5 may include a seating sensor which detects whether a driver is seated in a driver seat, a face direction sensor which detects a direction of a face of the driver, and a human sensor which detects whether there is a person in the vehicle.

The external sensor 6 may acquire information about the outside of the host vehicle. The external sensor is at least one of a camera, a radar, a LiDAR, and the like. The external sensor 6 acquires information about the outside of the host vehicle, which includes surroundings of the vehicle 1 (other vehicles, pedestrians, road shapes, traffic signs, obstacles, or the like), and outputs the information to the vehicle control unit 3. Alternatively, the external sensor 6 may include a weather sensor which detects a weather condition, an illuminance sensor which detects illuminance of the surroundings of the vehicle 1, and the like.

The camera includes an imaging element such as a charge-coupled device (CCD) or a complementary MOS (CMOS). The camera is a camera that detects visible light or an infrared camera that detects infrared rays.

The radar is a millimeter wave radar, a microwave radar, a laser radar, or the like.

The LiDAR is an abbreviation for Light Detection and Ranging or Laser Imaging Detection and Ranging. The LiDAR is a sensor which generally emits invisible light forward and acquires information about a distance to an object, a shape of the object, a material of the object, color of the object, and the like based on the emitted light and reflected light.

The lamp 7 is at least one of a headlamp or a position lamp provided at a front portion of the vehicle 1, a rear combination lamp provided at a rear portion of the vehicle 1, a turn signal lamp provided at the front portion or a side portion of the vehicle, and various lamps which inform pedestrians or other vehicle drivers of a situation of the host vehicle.

The HMI 8 includes an input unit that receives input operation from the driver and an output unit that outputs traveling information or the like to the driver. The input unit includes a steering wheel, an accelerator pedal, a brake pedal, a driving mode changeover switch which switches a driving mode of the vehicle 1, and the like. The output unit is a display that displays various types of traveling information.

The GPS 9 acquires current position information of the vehicle 1 and outputs the acquired current position information to the vehicle control unit 3. The wireless communication unit 10 receives traveling information of other vehicles around the vehicle 1 from other vehicles and transmits traveling information of the vehicle 1 to other vehicles (inter-vehicle communication). The wireless communication unit 10 further receives infrastructure information from infrastructure equipment such as traffic lights and sign lights and transmits traveling information of the vehicle 1 to the infrastructure equipment (road-to-vehicle communication). The map information storage unit 11 is an external storage device such as a hard disk drive, in which map information is stored, and outputs the map information to the vehicle control unit 3.

When the vehicle 1 travels in the automatic driving mode, the vehicle control unit 3 automatically generates at least one of a steering control signal, an accelerator control signal, and a brake control signal based on the traveling state information, the surrounding information, the current position information, the map information, and the like. The steering actuator 12 receives the steering control signal from the vehicle control unit 3 and controls the steering device 13 based on the received steering control signal. The brake actuator 14 receives the brake control signal from the vehicle control unit 3 and controls the brake device 15 based on the received brake control signal. The accelerator actuator 16 receives the accelerator control signal from the vehicle control unit 3 and controls the accelerator device 17 based on the received accelerator control signal. In this way, traveling of the vehicle 1 is automatically controlled by the vehicle system 2 in the automatic driving mode.

On the other hand, when the vehicle 1 travels in a manual driving mode, the vehicle control unit 3 generates the steering control signal, the accelerator control signal, and the brake control signal according to manual operation of the driver to the accelerator pedal, the brake pedal, and the steering wheel. In this way, the steering control signal, the accelerator control signal, and the brake control signal are generated by the manual operation of the driver, and accordingly traveling of the vehicle 1 is controlled by the driver in the manual driving mode.

Next, the driving mode of the vehicle 1 will be described. The driving mode includes the automatic driving mode and the manual driving mode. The automatic driving mode includes a fully automatic driving mode, an advanced driving assistance mode, and a driving assistance mode. In the fully automatic driving mode, the vehicle system 2 automatically performs all traveling controls including steering control, brake control, and accelerator control while the driver cannot drive the vehicle 1. In the advanced driving assistance mode, the vehicle system 2 automatically performs all traveling controls including the steering control, the brake control, and the accelerator control while the driver does not drive the vehicle 1 although the driver can drive the vehicle 1. In the driving assistance mode, the vehicle system 2 automatically performs a part of the traveling controls including the steering control, the brake control, and the accelerator control while the driver drives the vehicle 1 under driving assistance of the vehicle system 2.

On the other hand, in the manual driving mode, the vehicle system 2 does not automatically perform the traveling controls while the driver drives the vehicle 1 without the driving assistance of the vehicle system 2.

The driving mode of the vehicle 1 may be switched by operating the driving mode changeover switch. In this case, the vehicle control unit 3 switches the driving mode of the vehicle 1 between the four driving modes (the fully automatic driving mode, the advanced driving assistance mode, the driving assistance mode, and the manual driving mode) according to operation of the driver on the driving mode changeover switch. The driving mode of the vehicle 1 may also be automatically switched based on information about a travelable section where an automatic driving vehicle can travel and a traveling prohibited section where the automatic driving vehicle is prohibited or information about outside weather conditions. In this case, the vehicle control unit 3 switches the driving mode of the vehicle 1 based on these types of information. Further, the driving mode of the vehicle 1 may be automatically switched by using the seating sensor, the face direction sensor, or the like. In this case, the vehicle control unit 3 switches the driving mode of the vehicle 1 based on an output signal from the seating sensor or the face direction sensor.

Referring back to FIG. 1, the vehicle 1 includes, as the external sensor 6, a front LiDAR 6f, a rear LiDAR 6b, a right LiDAR 6r, a left LiDAR 61, a front camera 6c, and a rear camera 6d. The front LiDAR 6f acquires information about front of the vehicle 1. The rear LiDAR 6b acquires information about rear of the vehicle 1. The right LiDAR 6r acquires information about right of the vehicle 1. The left LiDAR 61 acquires information about left of the vehicle 1. The front camera 6c acquires information about front of the vehicle 1. The rear camera 6d acquires information about rear of the vehicle 1.

In the example shown in FIG. 1, the front LiDAR 6f is provided at the front portion of the vehicle 1, the rear LiDAR 6b is provided at the rear portion of the vehicle 1, the right LiDAR 6r is provided at a right portion of the vehicle 1, and the left LiDAR 61 is provided at a left portion of the vehicle 1, but the present invention is not limited thereto. For example, the front LiDAR, the rear LiDAR, the right LiDAR, and the left LiDAR may be collectively arranged at a ceiling portion of the vehicle 1.

The vehicle 1 includes a right headlamp 7r and a left headlamp 71 as the lamp 7. The right headlamp 7r is provided at a right front portion of the vehicle 1 and the left headlamp 71 is provided at a left front portion of the vehicle 1. The right headlamp 7r is provided rightward from the left headlamp 71.

The vehicle 1 includes a front window 1f and a rear window 1b.

The vehicle 1 includes the cleaner system 100 according to the embodiment of the present invention. The cleaner system 100 removes foreign materials such as water droplets, mud, and dust adhering to cleaning objects using a cleaning liquid. In the present embodiment, the cleaner system 100 includes a front window washer (hereinafter referred to as front WW) 101, a rear window washer (hereinafter referred to as rear WW) 102, a front LiDAR cleaner (hereinafter referred to as front LC) 103, a rear LiDAR cleaner (hereinafter referred to as rear LC) 104, a right LiDAR cleaner (hereinafter referred to as right LC) 105, a left LiDAR cleaner (hereinafter referred to as left LC) 106, a right headlamp cleaner (hereinafter referred to as right HC) 107, a left headlamp cleaner (hereinafter referred to as left HC) 108, a front camera cleaner 109a, and a rear camera cleaner 109b. Each of the cleaners 101 to 109b includes one or more nozzles and discharges the cleaning liquid (a fluid) from the nozzles toward the cleaning objects.

The front WW 101 may clean the front window 1f. The rear WW 102 may clean the rear window 1b. The front LC 103 may clean the front LiDAR 6f The rear LC 104 may clean the rear LiDAR 6b. The right LC 105 may clean the right LiDAR 6r. The left LC 106 may clean the left LiDAR 61. The right HC 107 may clean the right headlamp 7r. The left HC 108 may clean the left headlamp 71. The front camera cleaner 109a may clean the front camera 6c. The rear camera cleaner 109b may clean the rear camera 6d. In the following description, the front camera cleaner 109a and the rear camera cleaner 109b may be collectively referred to as camera cleaners 109.

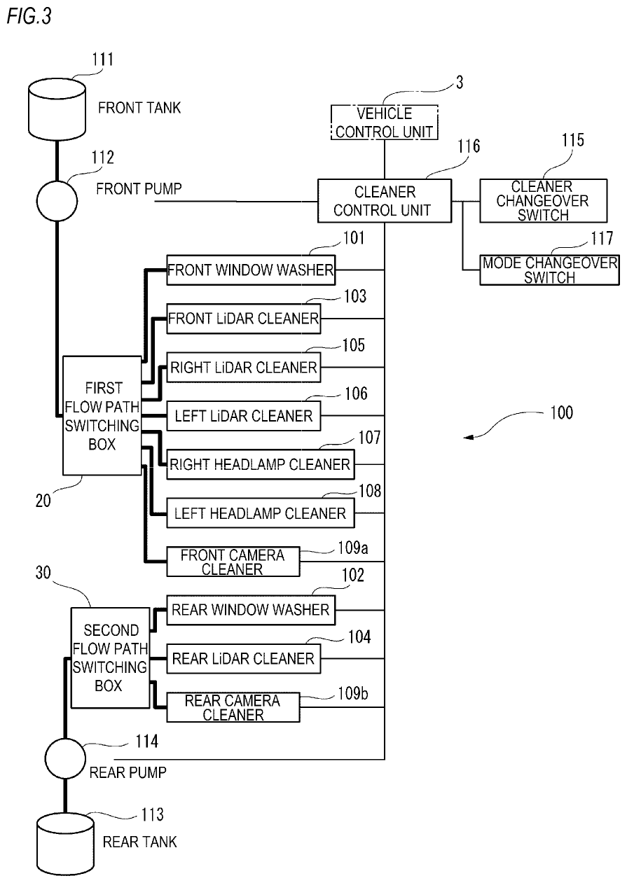

FIG. 3 is a block diagram of the cleaner system 100. In addition to the cleaners 101 to 109b, the cleaner system 100 includes a front tank 111, a front pump 112, a rear tank 113, and a rear pump 114.

The front WW 101, the front LC 103, the right LC 105, the left LC 106, the right HC 107, the left HC 108, and the front camera cleaner 109a are connected to the front tank 111 via the front pump 112. The front pump 112 sends a cleaning liquid stored in the front tank 111 to the front WW 101, the front LC 103, the right LC 105, the left LC 106, the right HC 107, the left HC 108, and the camera cleaner 109.

The rear WW 102, the rear LC 104, and the rear camera cleaner 109b are connected to the rear tank 113 via the rear pump 114. The rear pump 114 sends a cleaning liquid stored in the rear tank 113 to the rear WW 102, the rear LC 104, and the rear camera cleaner 109b.

As shown in FIG. 3, the front pump 112 and a plurality of cleaners including the front WW 101, the front LC 103, the right LC 105, the left LC 106, the right HC 107, the left HC 108, and the front camera cleaner 109a are connected via a first flow path switching box 20. The rear pump 114 and a plurality of cleaners including the rear WW 102, the rear LC 104, and the rear camera cleaner 109b are connected via a second flow path switching box 30.

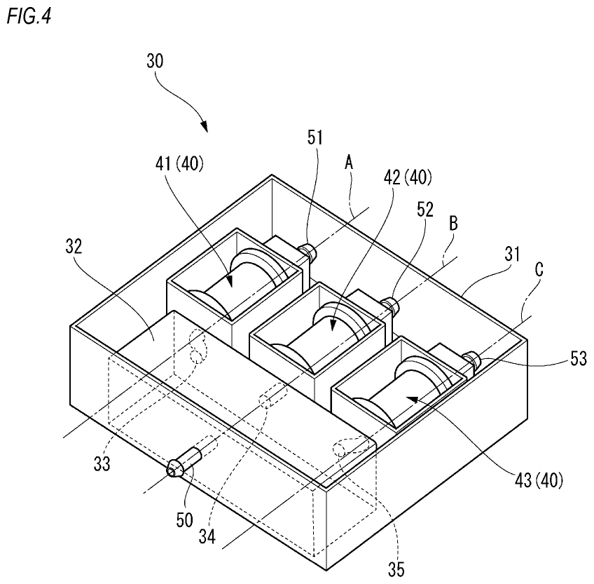

FIG. 4 is a perspective view of the second flow path switching box 30. The first flow path switching box 20 has the same configuration as the second flow path switching box 30 except that the number of solenoid valves 40 is different. As shown in FIG. 4, the second flow path switching box 30 includes a housing 31, a chamber 32, and a plurality of solenoid valves 40.

The housing 31 is formed of resin, for example. The housing 31 holds the inside thereof in a watertight manner. That is, the housing 31 prevents water from entering the inside and also prevents water from leaking to the outside. The housing 31 includes an inflow port 50, a first discharge port 51, a second discharge port 52, and a third discharge port 53.

The chamber 32 holds the inside thereof in a watertight manner. The chamber 32 includes an inlet connected to the inflow port 50 of the housing 31, a first outlet 33, a second outlet 34, and a third outlet 35. The inlet of the chamber 32 is connected to the rear pump 114 from the inflow port 50 via a hose (not shown). The cleaning liquid sent from the rear pump 114 is stored in the chamber 32.

A first solenoid valve 41 to a third solenoid valve 43 may switch to permitting and not permitting discharge of the cleaning liquid from their outlets independently of each other. The first solenoid valve 41 to the third solenoid valve 43 have the same configuration.

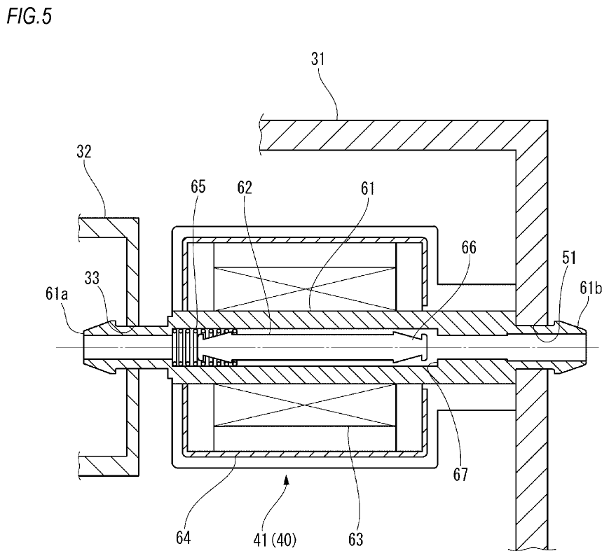

FIG. 5 is a cross-sectional view of the first solenoid valve 41. The first solenoid valve 41 may switch between an open state of permitting discharge of the cleaning liquid from the outlet and a closed state of not permitting discharge of the cleaning liquid. The first solenoid valve 41 includes a cylinder 61 having an inlet 61a and an outlet 61b, a plunger 62 (a movable element) linearly movable in the cylinder 61, and a coil 63 (stator) provided on an outer peripheral side of the cylinder 61, a yoke 64 covering the coil 63, and a spring 65. A tip end of the plunger 62 is provided with a sealing portion 66. The cylinder 61 is provided with a cylinder seat 67. With the sealing portion 66 being in close contact with the cylinder seat 67, the cylinder is closed.

In the present embodiment, the spring 65 is provided in the cylinder 61 in a compressed state. Due to an elastic restoring force of the spring 65, the sealing portion 66 provided on the plunger 62 is pressed against the cylinder seat 67. For this reason, in a normal state in which the coil 63 is not energized, the first solenoid valve 41 is in the closed state.

When the coil 63 is energized, the plunger 62 is attracted to the coil 63 against the elastic restoring force of the spring 65 so that the sealing portion 66 is separated from the cylinder seat 67. Accordingly, the solenoid valve 40 is brought into the open state.

The inlet 61a of the cylinder 61 of the first solenoid valve 41 is connected to the first outlet 33 of the chamber 32. The outlet 61b of the cylinder 61 of the first solenoid valve 41 is connected to the first discharge port 51 of the housing 31. Similarly, as shown in FIG. 4, the inlet 61a of the cylinder 61 of the second solenoid valve 42 is connected to the second outlet 34 of the chamber 32. The outlet 61b of the cylinder 61 of the second solenoid valve 42 is connected to the second discharge port 52 of the housing 31. The inlet 61a of the cylinder 61 of the third solenoid valve 43 is connected to the third outlet 35 of the chamber 32. The outlet 61b of the cylinder 61 of the third solenoid valve 43 is connected to the third discharge port 53 of the housing 31.

As shown in FIG. 4, movement directions A, B, and C of plungers 62 of the plurality of solenoid valves 40 are arranged in parallel to each other. As shown in FIG. 5, the solenoid valve 40 has a shape elongated in the moving direction of the plunger 62. By arranging the plurality of solenoid valves 40 such that the movement directions of the plungers 62 are parallel to each other, the flow path switching boxes 20, 30 may be small in size.

For the same reason, when the housing 31 is formed in a rectangular parallelepiped shape, it is preferable to provide a plurality of discharge ports 51 to 53 on a single surface.

The cleaner system 100 including at least the flow path switching boxes 20, 30, the plurality of cleaners 101 to 109b connected to discharge ports of the flow path switching boxes 20, 30, and the tanks 111, 113 that store the cleaning liquid and are connected to inflow ports 50 of the flow path switching boxes 20, 30 is mounted on the vehicle 1.

The cleaner system 100 including the flow path switching boxes 20, 30 facilitates mounting operation of the plurality of solenoid valves 40 to the vehicle 1 as compared with a cleaner system in which the plurality of solenoid valves 40 need to be individually attached to the vehicle.

In the above embodiment, the cleaning liquid sent from the rear pump 114 is temporarily stored in the chamber 32. For this reason, even when a large pressure fluctuation occurs in the pipeline between the solenoid valves 40 and pumps, for example, all the solenoid valves 40 are brought into the open state at one time, the pressure fluctuation can be buffered by the chamber 32 and the cleaning liquid can be stably discharged from the solenoid valves 40.

Although the first solenoid valve 41 is a normally-closed solenoid valve 40, the solenoid valve 40 may be a normally-open solenoid valve 40.

The above embodiment describes an example in which the plurality of solenoid valves 40 are arranged in the same plane, but the present invention is not limited thereto. A group of units including the solenoid valves 40 arranged in the same plane may be stacked in a direction orthogonal to the arrangement plane.

A flow path switching box may be mounted on the vehicle such that the normal line of the arrangement surface of the solenoid valves 40 extends in the up-down direction of the vehicle. The flow path switching box may be also mounted on the vehicle such that the normal line of the arrangement surface of the solenoid valves 40 extends in the left-right direction of the vehicle. The flow path switching box may be also mounted on the vehicle such that the normal line of the arrangement surface of the solenoid valves 40 extends in the front-rear direction of the vehicle.

Although the above embodiment describes an example in which two flow path switching boxes including the first flow path switching box 20 and the second flow path switching box 30 are mounted on the vehicle, one flow path switching box may be mounted on the vehicle or three or more flow path switching boxes may be mounted on the vehicle.

<Various Modifications>

Although the embodiment of the present invention has been described, it is needless to say that the technical scope of the present invention should not be interpreted as being limited to the description of the present embodiment. The present embodiment is merely an example and it would be appreciated by those skilled in the art that various modifications of the embodiment can be made within the scope of the invention described in the claims. The technical scope of the present invention should be determined based on the scope of the invention described in the claims and the equivalent scope thereof.

Although the present embodiment describes the driving mode of the vehicle as including the fully automatic driving mode, the advanced driving assistance mode, the driving assistance mode, and the manual driving mode, the driving mode of the vehicle should not be limited to these four modes. The driving mode of the vehicle may include at least one of these four modes. For example, only one of the driving modes of the vehicle may be operable.

Further, a classification and display form of the driving mode of the vehicle may be appropriately changed according to regulations or rules related to automatic driving in each country. Similarly, definitions of the “fully automatic driving mode”, the “advanced driving assistance mode”, and the “driving assistance mode” in the description of the present embodiment are merely examples and may be appropriately changed according to regulations or rules related to automatic driving in each country.

Although the above embodiment describes an example in which the cleaner system 100 is mounted on a vehicle capable of automatic driving, the cleaner system 100 may be mounted on a vehicle not capable of automatic driving.

Although the above embodiment describes an example in which the cleaners 101, 103, 105 to 109a are connected to the front tank 111 and the cleaners 102, 104, 109b are connected to the rear tank 113, the present invention is not limited thereto.

The cleaners 101 to 109b may be connected to one tank. The cleaners 101 to 109b may also be connected to different tanks.

Alternatively, the cleaners 101 to 109b may be connected to a common tank for each type of cleaning objects. For example, the cleaners 103 to 106 for cleaning the LiDAR may be connected to a first common tank and the cleaners 107 and 108 for cleaning the headlamp may be connected to a second tank different from the first tank.

Alternatively, the cleaners 101 to 109b may be connected to a common tank for each arrangement position of the cleaning objects. For example, the front WW 101, the front LC 103, and the front camera cleaner 109a may be connected to a common front tank, the right LC 105 and the right HC 107 may be connected to a common right tank, the rear WW 102, the rear LC 104, and the rear camera cleaner 109b may be connected to a common rear tank, and the left LC 106 and the left HC 108 may be connected to a common left tank.

1. A flow path switching box comprising:
a housing including an inflow port and a plurality of discharge ports;
a chamber connected to the inflow port; and
a plurality of solenoid valves provided in the housing, the plurality of solenoid valves each including a stator and a movable element movable relative to the stator,
wherein the plurality of solenoid valves have inlets connected to the chamber and outlets connected respectively to the discharge ports,
wherein the plurality of solenoid valves are configured to switch to permitting and not permitting discharge of a fluid from the outlets independently of each other, and
wherein the plurality of solenoid valves are arranged in parallel to each other in a moving direction of the movable element.

2. A vehicle cleaner system comprising:
the flow path switching box according to claim 1;
a plurality of cleaners connected respectively to the outlets; and
a tank connected to the inflow port and storing a cleaning liquid.
